(19) United States
(12) Patent Application Publication
(10) Pub. No.: US 2023/0139260 A1
(43) Pub. Date: May 4, 2023

(54) PHOTOGRAPHING CONTROL APPARATUS, SYSTEM, METHOD, AND NON-TRANSITORY COMPUTER-READABLE MEDIUM STORING PROGRAM

(71) Applicant: NEC Corporation, Minato-ku, Tokyo (JP)

(72) Inventors: Akira KAMEI, Tokyo (JP); Takeshi YAMAGUCHI, Tokyo (JP); Honami YUKI, Tokyo (JP); Shuuji KIKUCHI, Tokyo (JP)

(73) Assignee: NEC Corporation, Minato-ku, Tokyo (JP)

(21) Appl. No.: 17/801,650

(22) PCT Filed: Mar. 10, 2020
(86) PCT No.: PCT/JP2020/010290

§ 371 Date: Aug. 23, 2022

(51) Int. Cl. H04N 23/611; G06V 40/60; G06V 40/16; H04N 7/18

(52) U.S. Cl. CPC H04N 23/611; G06V 40/67; G06V 40/172; H04N 7/183

(57) ABSTRACT

A photographing control apparatus (2) includes an acquiring unit (21) configured to acquire a first photographed image of a person captured by a predetermined photographing device; an authentication controlling unit (22) configured to cause an authentication apparatus storing facial feature information of the person to perform first facial authentication of the first photographed image; a determining unit (23) configured to determine whether the first photographed image satisfies a predetermined photographing condition, if the first facial authentication has succeeded; and an output unit (24) configured to output a second photographed image of the person captured by the photographing device at a predetermined timing to a predetermined display device as an output image, if the photographing condition is satisfied.

### TECHNICAL FIELD

The present invention relates to photographing control apparatuses, systems, methods, and programs and particularly, relates to a photographing control apparatus, a system, a method, and a program each for controlling a photographing process.

### BACKGROUND ART

Patent Literature 1 discloses a technique related to a facial comparison system. The system according to Patent Literature 1 captures a number of images at a facility through face detection and saves an association between the photographed images and user IDs. This system then displays a number of photographed images associated with a user ID on a television set or the like in a separate room within the facility and, upon desired images having been selected from the displayed photographed images, outputs the set of selected images.

### CITATION LIST

### Patent Literature

Patent Literature 1: Japanese Unexamined Patent Application Publication No. 2016-126414

### SUMMARY OF INVENTION

### Technical Problem

With the technique according to Patent Literature 1, photographing needs to be performed a number of instances through face detection, and a user needs to select desired images from the number of photographed images. This case according to Patent Literature 1, however, poses a problem that the system cannot necessarily acquire photographed images captured under the condition that the user hopes for.

The present disclosure has been made to solve such a problem and is directed to providing a photographing control apparatus, a system, a method, and a program for providing a user with a desired photographed image by use of facial recognition technology.

### Solution to Problem

A photographing control apparatus according to a first aspect of the present disclosure includes:

acquiring means configured to acquire a first photographed image of a person captured by a predetermined photographing device;

authentication controlling means configured to cause an authentication apparatus storing facial feature information of the person to perform first facial authentication of the first photographed image;

determining means configured, if the first facial authentication has succeeded, to determine whether the first photographed image satisfies a predetermined photographing condition; and

output means configured, if the photographing condition is satisfied, to output a second photographed image of the person captured by the photographing device at a predetermined timing to a predetermined display device as an output image.

A photographing control apparatus according to a second aspect of the present disclosure includes:

storing means configured to store facial feature information of a predetermined person;

acquiring means configured to acquire a first photographed image of the person captured by a predetermined photographing device;

authentication controlling means configured to perform first facial authentication of the first photographed image by use of the facial feature information;

determining means configured, if the first facial authentication has succeeded, to determine whether the first photographed image satisfies a predetermined photographing condition; and

output means configured, if the photographing condition is satisfied, to output a second photographed image of the person captured by the photographing device at a predetermined timing to a predetermined display device as an output image.

A photographing control system according to a third aspect of the present disclosure includes:

a photographing device;

an authentication apparatus including storing means storing facial feature information of a predetermined person and authenticating means configured to perform facial authentication by use of the facial feature information;

a display device; and

a photographing control apparatus,

wherein the photographing control apparatus includes
acquiring means configured to acquire a first photographed image of a person captured by the photographing device, authentication controlling means configured to cause the
authentication apparatus to perform first facial authentication of the first photographed image,
determining means configured, if the first facial authentication has succeeded, to determine whether the first photographed image satisfies a predetermined photographing condition, and
output means configured, if the photographing condition is satisfied, to output a second photographed image of the person captured by the photographing device at a predetermined timing to the display device as an output image.

A photographing control method according to a fourth aspect of the present disclosure executed by a computer includes:

acquiring a first photographed image of a person captured by a predetermined photographing device;

causing an authentication apparatus storing facial feature information of the person to perform first facial authentication of the first photographed image;

determining, if the first facial authentication has succeeded, whether the first photographed image satisfies a predetermined photographing condition; and

outputting, if the photographing condition is satisfied, a second photographed image of the person captured by the photographing device at a predetermined timing to a predetermined display device as an output image.

A photographing control method according to a fifth aspect of the present disclosure executed by a computer configured to store facial feature information of a predetermined person includes:

acquiring a first photographed image of a person captured by a predetermined photographing device;

performing first facial authentication of the first photographed image by use of the facial feature information;

determining, if the first facial authentication has succeeded, whether the first photographed image satisfies a predetermined photographing condition; and

outputting, if the photographing condition is satisfied, a second photographed image of the person captured by the photographing device at a predetermined timing to a predetermined display device as an output image.

A photographing control program according to a sixth aspect of the present disclosure causes a computer to execute:

a process of acquiring a first photographed image of a person captured by a predetermined photographing device;

a process of causing an authentication apparatus storing facial feature information of the person to perform first facial authentication of the first photographed image;

a process of determining, if the first facial authentication has succeeded, whether the first photographed image satisfies a predetermined photographing condition; and

a process of outputting, if the photographing condition is satisfied, a second photographed image of the person captured by the photographing device at a predetermined timing to a predetermined display device as an output image.

A photographing control program according to a seventh aspect of the present disclosure causes a computer configured to store facial feature information of a predetermined person to execute:

a process of acquiring a first photographed image of a person captured by a predetermined photographing device;

a process of performing first facial authentication of the first photographed image by use of the facial feature information;

a process of determining, if the first facial authentication has succeeded, whether the first photographed image satisfies a predetermined photographing condition; and

a process of outputting, if the photographing condition is satisfied, a second photographed image of the person captured by the photographing device at a predetermined timing to a predetermined display device as an output image.

### Advantageous Effects of Invention

The present disclosure can provide a photographing control apparatus, a system, a method, and a program for providing a user with a desired photographed image by use of facial recognition technology.

### BRIEF DESCRIPTION OF DRAWINGS

FIG. 1 is a block diagram illustrating a configuration of a photographing control apparatus according to a first example embodiment.

FIG. 2 is a flowchart illustrating a flow of a photographing control method according to the first example embodiment.

FIG. 3 is a block diagram illustrating a configuration of a photographing control apparatus according to a second example embodiment.

FIG. 4 is a flowchart illustrating a flow of a photographing control method according to the second example embodiment.

FIG. 5 is a block diagram illustrating an overall configuration of a photographing control system according to a third example embodiment.

FIG. 6 is a block diagram illustrating a configuration of an authentication apparatus according to the third example embodiment.

FIG. 7 is a flowchart illustrating a flow of a facial information registration process according to the third example embodiment.

FIG. 8 is a flowchart illustrating a flow of a facial authentication process according to the third example embodiment.

FIG. 9 is a block diagram illustrating a configuration of a user terminal according to the third example embodiment.

FIG. 10 is a flowchart illustrating a flow of a photographing control process according to the third example embodiment.

FIG. 11 is a flowchart illustrating a flow of the photographing control process according to the third example embodiment.

FIG. 12 illustrates an example of a photographed image according to the third example embodiment.

FIG. 13 is a block diagram illustrating a configuration of a photographing control apparatus according to a fourth example embodiment.

FIG. 14 is a sequence diagram illustrating a flow of a photographing control process according to the fourth example embodiment.

FIG. 15 is a sequence diagram illustrating a flow of the photographing control process according to the fourth example embodiment.

FIG. 16 illustrates an example of a photographed image in which faces of strangers are subjected to mosaic processing according to the fourth example embodiment.

FIG. 17 illustrates an example of a photographed image in which the person is displayed prominently according to a fifth example embodiment.

FIG. 18 is a flowchart illustrating a flow of a photographing control process according to a sixth example embodiment.

FIG. 19 is a flowchart illustrating a flow of the photographing control process according to the sixth example embodiment.

FIG. 20 illustrates an example of a photographed image with gesture recognition according to the sixth example embodiment.

### EXAMPLE EMBODIMENT

Hereinafter, some example embodiments of the present disclosure will be described in detail with reference to the drawings. In the drawings, identical or corresponding elements are given identical reference characters, and duplicate description thereof will be omitted as necessary in order to make the description clearer.

### First Example Embodiment

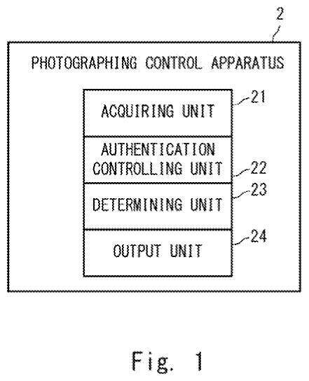

FIG. 1 is a block diagram illustrating a configuration of a photographing control apparatus 2 according to a first example embodiment. The photographing control apparatus 2 is an information processing apparatus that photographs a person at a predetermined timing by controlling a predetermined photographing device (not illustrated) if a predetermined photographing condition is satisfied. The photographing control apparatus 2 is connected to the photographing device, an authentication apparatus (not illustrated), and a display device (not illustrated).

Herein, the photographing device is, for example but not limited to, a camera installed in a public area. The display device is, for example but not limited to, digital signage installed near the photographing device or a user terminal possessed, for example, by a person to be photographed. The photographing device and the display device may be, for example, an integrated apparatus, such as a facial authentication terminal. The authentication apparatus has facial feature information of a person stored therein in advance. The authentication apparatus receives an input of a facial image or facial feature information from the photographing control apparatus 2, compares the received facial image or facial feature information against the pre-stored facial feature information, makes a determination as to a match or a mismatch, and outputs the determination result to the photographing control apparatus 2. In the case of a match, the determination result indicates that the facial authentication has succeeded. In the case of a mismatch, the determination result indicates that the facial authentication has failed.

The photographing control apparatus 2 includes an acquiring unit 21, an authentication controlling unit 22, a determining unit 23, and an output unit 24. The acquiring unit 21 acquires a first photographed image of a person captured by the predetermined photographing device. The authentication controlling unit 22 causes the authentication apparatus to perform first facial authentication of the first photographed image. The determining unit 23 determines whether the first photographed image satisfies a predetermined photographing condition, if the first facial authentication has succeeded. The predetermined photographing condition is a condition set in advance, for example, by the person. Examples of the predetermined photographing condition may include that a facial region of the person lies within a specific region in the photographed image, or that the degree of crowding caused by people detected within the photographed image is no lower than a predetermined value, or a combination thereof. If the photographing condition is satisfied, the output unit 24 outputs a second photographed image of the person captured by the photographing device at a predetermined timing to a predetermined display device (not illustrated) as an output image. The predetermined timing is, for example but not limited to, in three seconds or when a predetermined gesture is recognized.

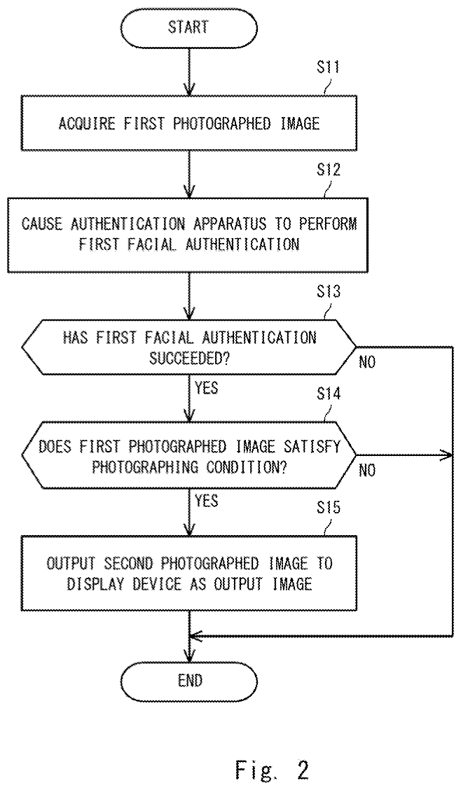

FIG. 2 is a flowchart illustrating a flow of a photographing control method according to the first example embodiment. First, the acquiring unit 21 acquires a first photographed image of a person captured by the predetermined photographing device (S11). Next, the authentication controlling unit 22 causes the authentication apparatus to perform first facial authentication of the first photographed image (S12). Then, the determining unit 23 determines whether the first facial authentication has succeeded (S13). If the first facial authentication has succeeded, the determining unit 23 determines whether the first photographed image satisfies a predetermined photographing condition (S14). If the first photographed image satisfies the photographing condition, the output unit 24 outputs a second photographed image of the person captured by the photographing device at a predetermined timing to a predetermined display device as an output image (S15). Herein, if the determination is NO at step S13 or if the determination is NO at S14, the process is terminated. At step S15, the output unit 24 may output the first photographed image to the predetermined display device as an output image.

In this manner, the present example embodiment can provide a user with a desired photographed image by use of facial recognition technology. Unlike the technique according to Patent Literature 1, the present example embodiment renders it unnecessary to select an image from a number of similar images and allows the user to confirm a photographed image instantly.

Herein, the photographing control apparatus 2 includes, as its components, a processor, a memory, and a storage device (none illustrated). The storage device stores a computer program that implements the processes of the photographing control method according to the present example embodiment. The processor loads the computer program from the storage device onto the memory and executes the computer program. Thus, the processor implements the functions of the acquiring unit 21, the authentication controlling unit 22, the determining unit 23, and the output unit 24.

Alternatively, the acquiring unit 21, the authentication controlling unit 22, the determining unit 23, and the output unit 24 may each be implemented by a dedicated piece of hardware. A part or the whole of the constituent elements of each device may be implemented by, for example, general-purpose or dedicated circuitry, a processor, or a combination thereof. Such constituent elements may be formed by a single chip or by a plurality of chips connected via a bus. A part or the whole of the constituent elements of each device may be implemented by a combination of the above-described circuitry or the like and a program. For the processor, a central processing unit (CPU), a graphics processing unit (GPU), a field-programmable gate array (FPGA), or the like can be used.

In a case where a part or the whole of the constituent elements of the photographing control apparatus 2 is implemented by a plurality of information processing apparatuses, circuitries, or the like, these information processing apparatuses, circuitries, or the like may be disposed centrally or distributedly. For example, these information processing apparatuses, circuitries, or the like may be implemented in a mode in which they are connected to each other via a communication network, as in, for example, a client server system or a cloud computing system. The function of the photographing control apparatus 2 may be provided in a Software as a Service (SaaS) format.

### Second Example Embodiment

A second example embodiment is a modification example of the first example embodiment described above. The photographing control apparatus 2 according to the first example embodiment causes an external authentication apparatus to perform facial authentication. In contrast, a photographing control apparatus 2a according to the second example embodiment performs facial authentication within the apparatus.

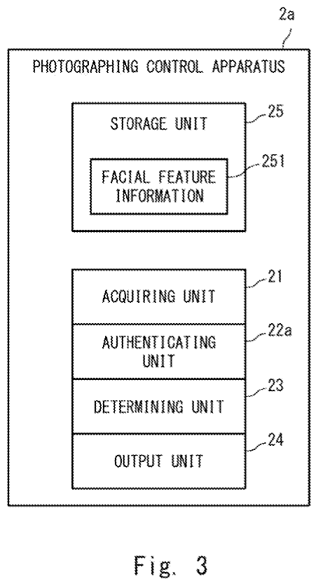

FIG. 3 is a block diagram illustrating a configuration of the photographing control apparatus 2a according to the second example embodiment. The photographing control apparatus 2a includes a storage unit 25, an acquiring unit 21, an authenticating unit 22a, a determining unit 23, and an output unit 24. The functions of the acquiring unit 21, the determining unit 23, and the output unit 24 are similar to those according to the first example embodiment, and thus description thereof will be omitted.

The storage unit 25 stores facial feature information of at least a predetermined person. The authenticating unit 22a performs first facial authentication of a first photographed image by use of facial feature information.

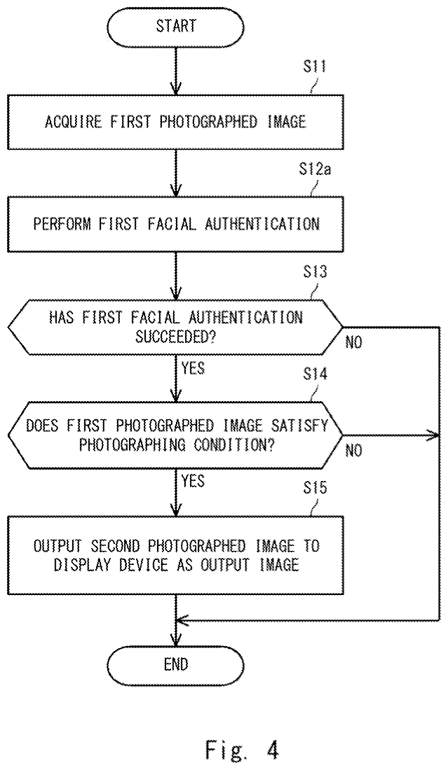

FIG. 4 is a flowchart illustrating a flow of a photographing control method according to the second example embodiment. In FIG. 4, step S12 of FIG. 2 is replaced by step S12a, and other steps are similar to the counterparts in FIG. 2. At step S12a, the authenticating unit 22a performs first facial authentication of the first photographed image by use of facial feature information.

In this manner, the second example embodiment too can provide advantageous effects similar to those provided by the first example embodiment described above.

### Third Example Embodiment

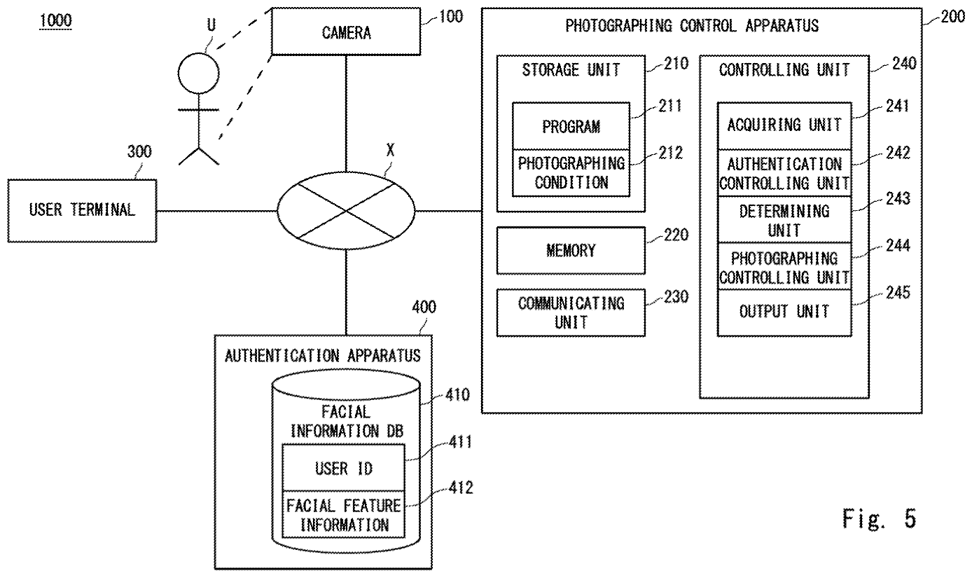

A third example embodiment is a specific example of the first example embodiment described above. FIG. 5 is a block diagram illustrating a configuration of a photographing control system 1000 according to the third example embodiment. The photographing control system 1000 includes a camera 100, a photographing control apparatus 200, a user terminal 300, and an authentication apparatus 400. The camera 100, the photographing control apparatus 200, the user terminal 300, and the authentication apparatus 400 are connected to each other via a network X. The network X is a wired or wireless communication circuit.

The camera 100 photographs a predetermined region including at least the face of a person U and transmits the photographed image to the photographing control apparatus 200 via the network X. The camera 100 can also perform photographing in accordance with a photographing instruction provided from the photographing control apparatus 200 via the network X. Herein, the camera 100 may be a part of a facial authentication terminal.

The authentication apparatus 400 includes a facial feature database (DB) 410. The facial feature DB 410 stores an association between a user ID 411 and facial feature information 412 of this user ID. The facial feature DB 410 is also referred to as a storage unit. Herein, the authentication apparatus 400 may delete the facial feature information 412 in the facial feature DB 410 in response to a request from the registered user of the facial feature information 412. Alternatively, the authentication apparatus 400 may delete the facial feature information 412 after a predefined time has passed since the registration of the facial feature information 412. The authentication apparatus 400, in response to receiving a facial authentication request from the outside, compares a facial image or facial feature information included in the received request against the facial feature information of each user and returns the result of the comparison (the result of the authentication) to the requestor.

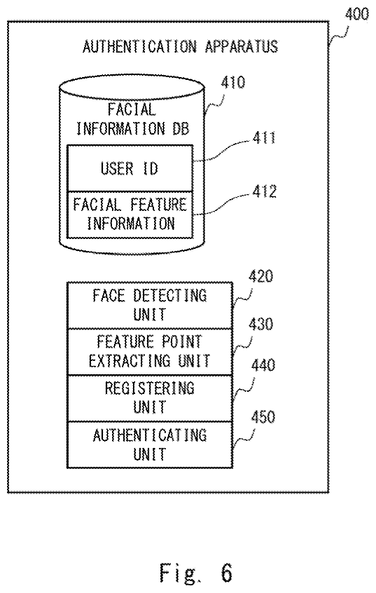

Next, a configuration and some functions of the authentication apparatus 400 will be described in detail. FIG. 6 is a block diagram illustrating a configuration of the authentication apparatus 400 according to the third example embodiment. The authentication apparatus 400 includes the facial information DB 410 described earlier, a face detecting unit 420, a feature point extracting unit 430, a registering unit 440, and an authenticating unit 450.

The face detecting unit 420 detects a facial region included in a registration image for registering facial information and outputs the detected facial region to the feature point extracting unit 430. The feature point extracting unit 430 extracts feature points from the facial region detected by the face detecting unit 420 and outputs facial feature information to the registering unit 440. In this example, the facial feature information is a set of extracted feature points. The feature point extracting unit 430 also extracts feature points included in a facial image received from the photographing control apparatus 200 and outputs facial feature information to the authenticating unit 450.

The registering unit 440 issues a new user ID 411 when registering facial feature information. The registering unit 440 registers an association between the issued user ID 411 and facial feature information 412 extracted from the registration image into the facial information DB 410. The authenticating unit 450 performs facial authentication by use of the facial feature information 412. Specifically, the authenticating unit 450 compares the facial feature information extracted from the facial image against the facial feature information 412 in the facial information DB 410. The authenticating unit 450 returns, to the photographing control apparatus 100a, the presence or absence of a match between the two pieces of facial feature information. The presence or absence of a match between the two pieces of facial feature information corresponds to the success or failure of the authentication.

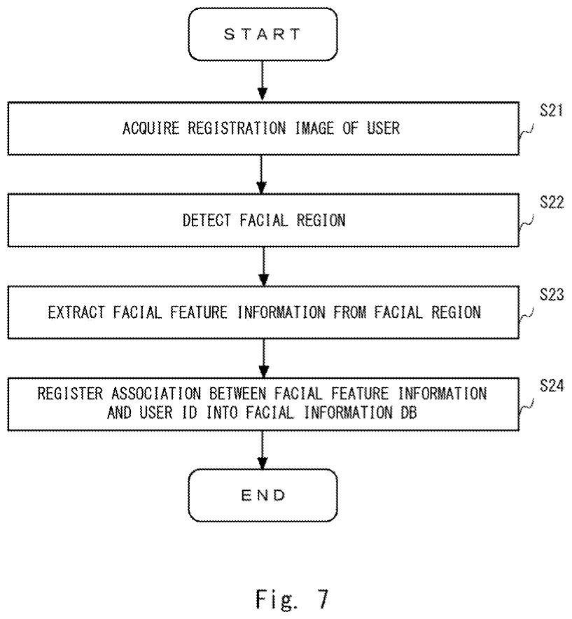

FIG. 7 is a flowchart illustrating a flow of a facial information registration process performed by the authentication apparatus 400. First, the authentication apparatus 400 acquires a registration image included in a facial information registration request (step S21). For example, the authentication apparatus 400 receives the facial information registration request from the user terminal 300 or the like via the network X. Next, the face detecting unit 420 detects a facial region included in the registration image (step S22). Next, the feature point extracting unit 430 extracts feature points from the facial region detected at step S22 and outputs facial feature information to the registering unit 440 (step S23). Lastly, the registering unit 440 issues a user ID 411 and registers an association between this user ID 411 and facial feature information 412 into the facial information DB 410 (step S204). Herein, the authentication apparatus 400 may receive the facial feature information 412 from the user terminal 300 or the like and register an association between the facial feature information 412 and the user ID 411 into the facial information DB 410.

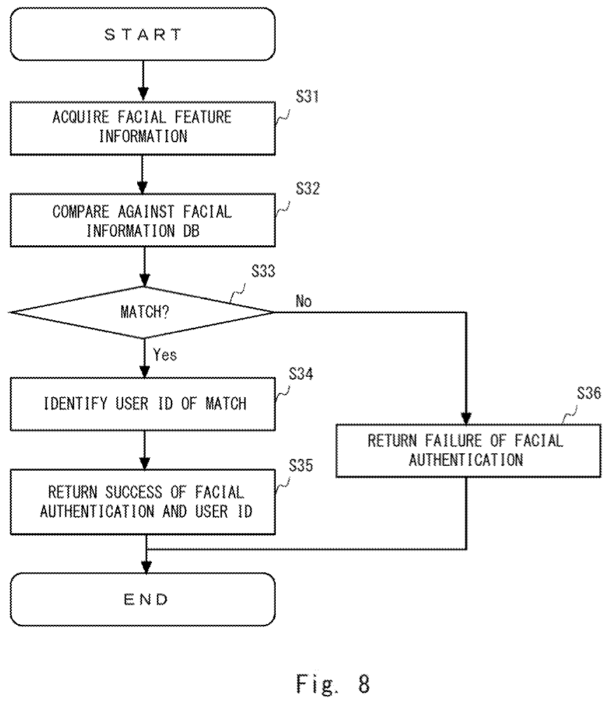

FIG. 8 is a flowchart illustrating a flow of a facial authentication process performed by the authentication apparatus 400. First, the feature point extracting unit 430 acquires facial feature information from a facial image received from the photographing control apparatus 200 (step S31). For example, the authentication apparatus 400 receives the facial image from the photographing control apparatus 200 and extracts the facial feature information as in steps S21 to S23. Alternatively, the authentication apparatus 400 may receive the facial feature information from the photographing control apparatus 200. Next, the authenticating unit 450 compares the acquired facial feature information against the facial feature information 412 in the facial information DB 410 (step S32). If the facial feature information has a match (Yes at step S33), the authenticating unit 450 identifies the user ID 411 of the user that the facial feature information has matched with (step S34) and returns the success of the facial authentication and the identified user ID 411 to the photographing control apparatus 200 (step S35). If the facial feature information has no match (No at step S33), the authenticating unit 450 returns the failure of the facial authentication to the photographing control apparatus 200 (step S36).

At step S32, the authenticating unit 450 does not need to compare the facial feature information against all the facial feature information 412 in the facial information DB 410. For example, the authenticating unit 450 may perform the comparison preferentially against the facial feature information registered on the day of receiving the facial authentication request. Alternatively, even if the facial feature information has been registered prior to the day before, if a user has reserved to perform photographing (by use of the camera 100 and the photographing control apparatus 200) on a specific day, the authenticating unit 450 may perform the comparison preferentially against the facial feature information of the user who has made the reservation. Such configurations can improve the comparison speed. If the preferential comparison described above has failed, the authenticating unit 450 may perform the comparison against all the remaining pieces of facial feature information.

The user terminal 300 is a terminal possessed by the person U and is an example of the display device described above. The user terminal 300 is, for example but not limited to, a mobile phone terminal, a smartphone, a tablet terminal, or a personal computer (PC) equipped with or connected to a camera. The user terminal 300 may also be called a display terminal and is associated with the user ID or the facial feature information of the person U. In other words, the user terminal 300 is a display terminal that can be identified by the user ID or the facial feature information in the photographing control apparatus 200 or the like. The user terminal 300 is, for example, a terminal to which the person U has logged in with his or her user ID.

The user terminal 300 transmits, to the authentication apparatus 400, a registration image to be used for facial authentication of the person U and makes a facial information registration request. Herein, the user terminal 300 may transmit facial feature information extracted from the registration image to the authentication apparatus 400 and make a facial information registration request. The user terminal 300 may receive an output image from the photographing control apparatus 200. Herein, the photographing control system 1000 may include digital signage, in place of the user terminal 300, as a display device that receives and displays an output image. The photographing control system 1000 can use, as a predetermined photographing device that obtains a photographed image, either a facial authentication terminal equipped with the camera 100 or the user terminal 300. The camera 100 may transmit a registration image to the authentication apparatus 400 and make a facial information registration request. The facial authentication terminal or the user terminal 300 may transmit facial feature information extracted from the registration image to the authentication apparatus 400 and make a facial information registration request.

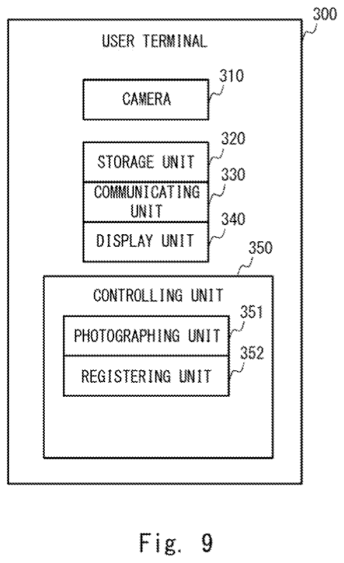

Next, the user terminal 300 will be described in detail. FIG. 9 is a block diagram illustrating a configuration of the user terminal 300 according to the third example embodiment. The user terminal 300 includes a camera 310, a storage unit 320, a communicating unit 330, a display unit 340, and a controlling unit 350. The camera 310 may be the camera 100 described above. The storage unit 320 is a storage device that stores a program for implementing each function of the user terminal 300. The communicating unit 330 is a communication interface with the network X. The display unit 340 is the display device mentioned above. The controlling unit 350 controls hardware components of the user terminal 300. The controlling unit 350 includes a photographing unit 351 and a registering unit 352.

The photographing unit 351 controls the camera 310 to obtain a registration image of the person U. The registration image is an image that includes a facial region of at least this user. The registering unit 352 transmits a facial information registration request including the registration image to the authentication apparatus 400 via the network X. The user terminal 300 receives an output image from the photographing control apparatus 200 via the network X and displays the output image on a screen of the display unit 340.

Referring back to FIG. 5, a configuration and some functions of the photographing control apparatus 200 will be described. The photographing control apparatus 200 includes a storage unit 210, a memory 220, a communicating unit 230, and a controlling unit 240. The storage unit 210 is a storage device, such as a hard disk or a flash memory. The storage unit 210 stores a program 211 and a photographing condition 212. The program 211 is a computer program equipped with processes of the photographing control method according to the present example embodiment. The photographing condition 212 is the photographing condition described above according to the example embodiment and is information set in advance by a given person.

The memory 220 is a volatile storage device, such as a random-access memory (RAM), and is a storage area for temporarily holding information while the controlling unit 240 operates. The communicating unit 230 is a communication interface with the network X.

The controlling unit 240 is a processor, or a control device, that controls each component of the photographing control apparatus 200. The controlling unit 240 loads the program 211 from the storage unit 210 onto the memory 220 and executes the program 211. Thus, the controlling unit 240 implements the functions of an acquiring unit 241, an authentication controlling unit 242, a determining unit 243, a photographing controlling unit 244, and an output unit 245.

The acquiring unit 241 is an example of the acquiring unit 21 described above. The acquiring unit 241 acquires a photographed image of the person U captured by the camera 100 via the network X.

The authentication controlling unit 242 is an example of the authentication controlling unit 22 described above. The authentication controlling unit 242 transmits a facial authentication request including the acquired photographed image to the authentication apparatus 400 via the network X and receives the result of facial authentication from the authentication apparatus 400. Herein, the authentication controlling unit 242 may detect a facial region of the person U from the photographed image and incorporate the image of the facial region into the facial authentication request. Furthermore, the authentication controlling unit 242 may extract facial feature information from the facial region and incorporate the facial feature information into the facial authentication request. In other words, the authentication controlling unit 242 causes the authentication apparatus to perform facial authentication of the photographed image.

The determining unit 243 is an example of the determining unit 23 described above. If the facial authentication of a first photographed image has succeeded, the determining unit 243 determines whether this first photographed image satisfies the photographing condition 212.

If the first photographed image satisfies the photographing condition 212, the photographing controlling unit 244 causes the camera 100 to capture a second photographed image in response to a photographing instruction received from the user terminal 300 in accordance with an operation of the person U. Thus, photographing can be performed at a desired photographing timing of the person U.

The output unit 245 is an example of the output unit 24 described above. The output unit 245 outputs the second photographed image as an output image to the user terminal 300 via the network X. If the first photographed image fails to satisfy the photographing condition 212, the output unit 245 outputs a predetermined message to the user terminal 300. Thus, the person U can readily find that his or her position or orientation relative to the camera 100 does not satisfy the photographing condition. Furthermore, the output unit 245 may output, as a predetermined message, a message guiding the person U in order to satisfy the photographing condition 212. Thus, the person U can readily find what he or she needs to do to satisfy the photographing condition 212, which can facilitate the acquisition of a desired photographed image.

Herein, if facial authentication of the first photographed image has succeeded, the authentication controlling unit 242 acquires, from the authentication apparatus 400, the user ID for which the facial authentication has succeeded. Then, the output unit 245 identifies the user terminal 300 associated with the acquired user ID and outputs, to the identified user terminal 300, the first photographed image and a message indicating that photographing can be performed. Meanwhile, if facial authentication of a second photographed image has succeeded, the output unit 245 outputs the second photographed image to the identified user terminal 300 as an output image.

Herein, the output unit 245 may output the output image immediately or after a predefined time has passed.

The photographing control apparatus 200 may have embedded therein the camera 100, digital signage serving as a display device, or a part or the whole of the authentication apparatus 400.

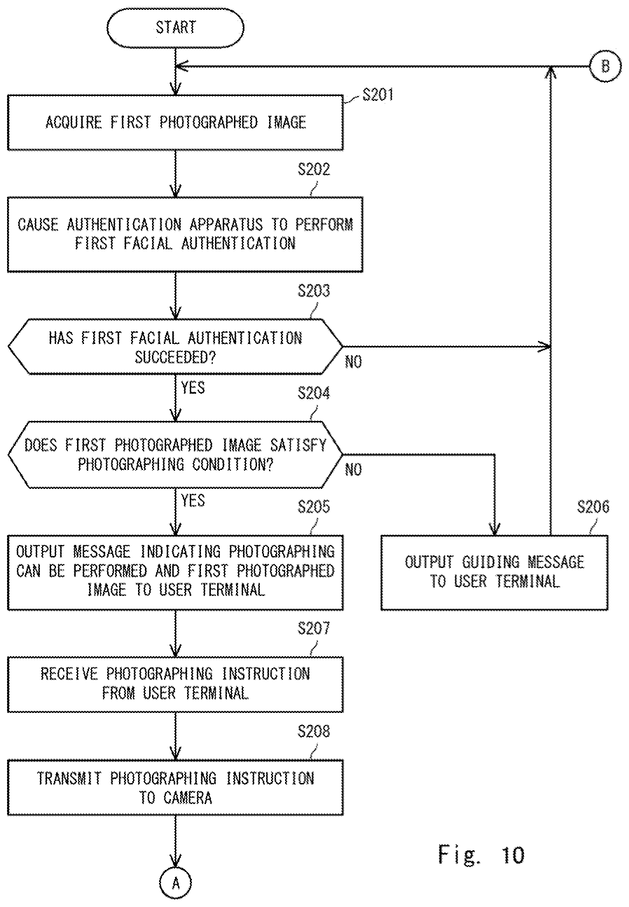

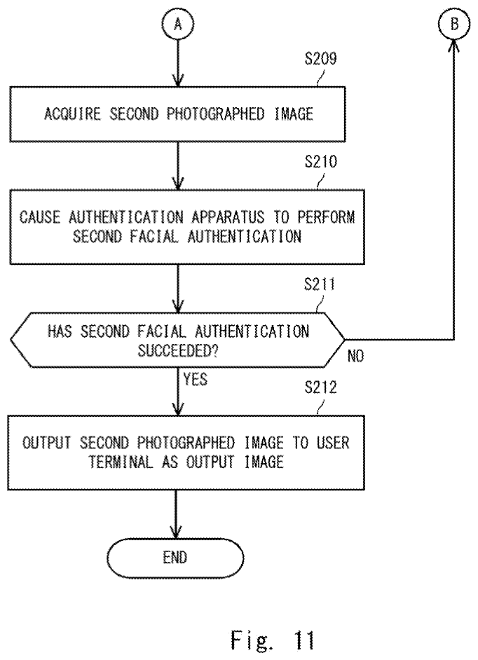

FIGS. 10 and 11 show a flowchart illustrating a flow of a photographing control process according to the third example embodiment. First, the acquiring unit 241 acquires a first photographed image of the person U captured by the camera 100 (S201). Next, the authentication controlling unit 242 causes the authentication apparatus 400 to perform first facial authentication (S202). Specifically, the authentication controlling unit 242 transmits a facial authentication request including the first photographed image to the authentication apparatus 400 via the network X. Then, the authentication controlling unit 242 receives the result of facial authentication from the authentication apparatus 400. The result of facial authentication includes information indicating that the facial authentication has succeeded and the corresponding user ID if the facial authentication has succeeded or includes information indicating that the facial authentication has failed if the facial authentication has failed.

Next, the determining unit 243 determines whether the first facial authentication has succeeded (S203). Specifically, the determining unit 243 determines whether the received result of facial authentication includes information indicating that the facial authentication has succeeded. If the first facial authentication has succeeded, the determining unit 243 determines whether the first photographed image satisfies the photographing condition 212 (S204). For example, the determining unit 243 analyzes the first photographed image and determines whether the facial region of the person U lies within a specific region in the photographed image or whether the degree of crowding caused by people detected within the photographed image is no lower than a predetermined value.

If the first photographed image fails to satisfy the photographing condition 212 at step S204, the output unit 245 outputs a guiding message to the user terminal 300 via the network X (S206). The guiding message may be, for example, a message prompting the person U to move his or her facial region into the specific region within the first photographed image. Alternatively, the guiding message may be, for example, a message prompting the person U to wait where he or she is until the degree of crowding becomes no lower than the predetermined value. The guiding message, however, is not limited to the examples above.

If the first facial authentication has failed at step S203 or after step S206, the process returns to step S201.

If the first photographed image satisfies the photographing condition 212 at step S204, the output unit 245 outputs a message indicating that photographing can be performed and the first photographed image to the user terminal 300 via the network X (S205). Then, the photographing controlling unit 244 receives a photographing instruction from the user terminal 300 (S207). The photographing controlling unit 244 then transmits the photographing instruction to the camera 100 via the network X (S208).

Thereafter, the acquiring unit 241 acquires a second photographed image of the person U captured by the camera 100 via the network X (S209). Next, the authentication controlling unit 242 causes the authentication apparatus 400 to perform second facial authentication (S210). Specifically, the authentication controlling unit 242 transmits a facial authentication request including the second photographed image to the authentication apparatus 400 via the network X. Then, the authentication controlling unit 242 receives the result of facial authentication from the authentication apparatus 400.

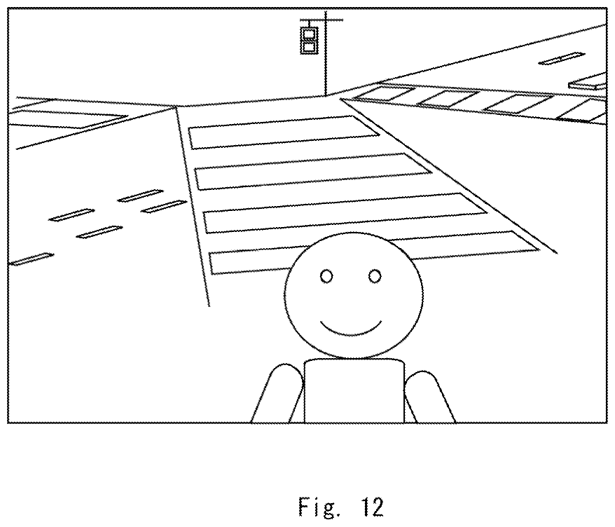

Then, the determining unit 243 determines whether the second facial authentication has succeeded (S211). If the second facial authentication has succeeded, the output unit 245 outputs the second photographed image to the user terminal 300 via the network X (S212). Thus, the user terminal 300 displays the received second photographed image on the screen of the display unit 340. FIG. 12 illustrates an example of a photographed image (output image) according to the third example embodiment.

In this manner, the third example embodiment enables photographing under the condition desired by a user (person U) by use of facial recognition technology. Moreover, since photographing is performed upon the reception of a photographing instruction from the user, photographing through facial recognition can be achieved at the user's desired timing. Furthermore, since a guiding message is output to the user if the photographing condition is not satisfied, the user can make fine adjustments to the orientation or position of his or her face or body in accordance with the guiding message. Accordingly, photographing through facial recognition can be achieved at the user's desired angle.

According to the third example embodiment, step S207 of FIG. 10 is not essential. Instead, at step S205, the output unit 245 may output an advance photographing notice for notifying the user of a predetermined timing. The advance photographing notice may be a message stating, for example, “Photographing in N seconds.” The “N seconds” may then be counted down. Then, the photographing controlling unit 244 may perform step S208 at a predetermined timing—for example, in N seconds.

### Fourth Example Embodiment

A fourth example embodiment is an improvement example of the third example embodiment described above. A photographed image according to the third example embodiment may capture faces of other persons as well beside that of the person U. In that case, the privacy of those persons captured in the photographed image needs to be considered even if the photographing condition of the person U is satisfied. Therefore, according to the fourth example embodiment, the face of a person other than the person to be photographed in a photographed image is subjected to mosaic processing, and the resulting image is output as an output image.

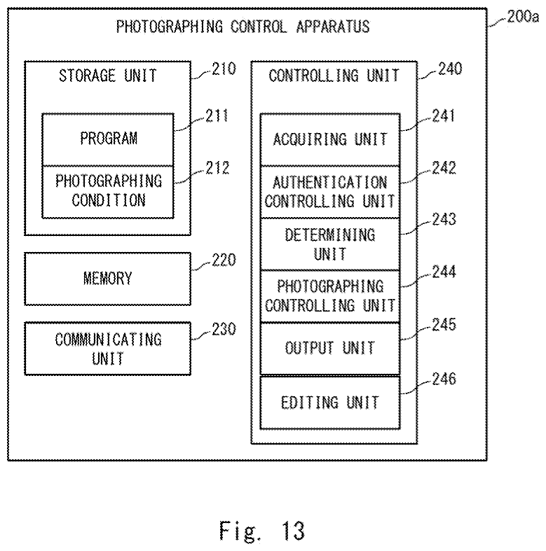

FIG. 13 is a block diagram illustrating a configuration of a photographing control apparatus 200a according to the fourth example embodiment. A photographing control system according to the fourth example embodiment includes the photographing control apparatus 200a replacing the photographing control apparatus 200 in the photographing control system 1000. Other configurations are similar to those according to the third example embodiment, and thus description thereof will be omitted below.

The photographing control apparatus 200a has a configuration in which an editing unit 246 is added to the photographing control apparatus 200. The editing unit 246 is an example of a first editing unit. If second facial authentication has succeeded, the editing unit 246 identifies, in the second photographed image, a facial region other than the facial region corresponding to the facial feature information that the second facial authentication has successfully authenticated and edits the second photographed image so as to reduce the recognizability of the identified facial region. For example, the editing unit 246 performs mosaic processing on faces of persons other than the person U. Then, the output unit 245 outputs the edited image to the user terminal 300 as an output image.

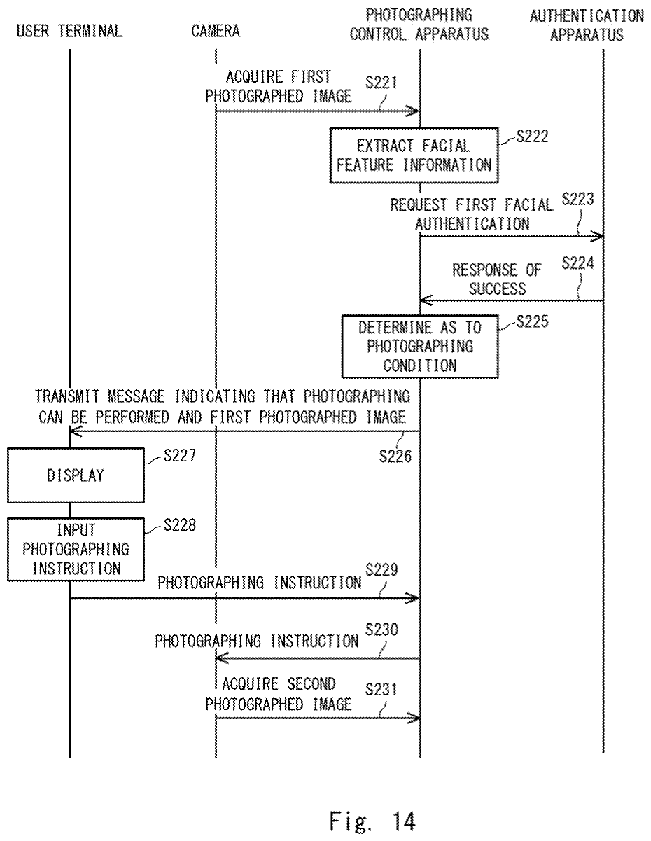

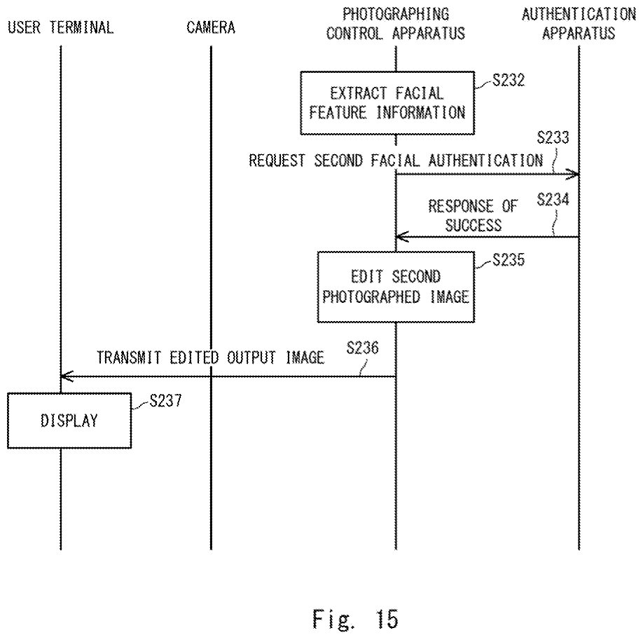

FIGS. 14 and 15 show a sequence diagram illustrating a flow of a photographing control process according to the fourth example embodiment. First, the camera 100 transmits a first photographed image capturing a predetermined region including the person U to the photographing control apparatus 200a via the network X. Thus, the acquiring unit 241 of the photographing control apparatus 200a acquires the first photographed image (S221). Next, the authentication controlling unit 242 detects a facial region from the first photographed image and extracts facial feature information from the facial region (S222). Then, the authentication controlling unit 242 transmits a facial authentication request including the extracted facial feature information to the authentication apparatus 400 via the network X (S223).

In response to the facial authentication request, the authentication apparatus 400 compares the facial feature information included in the facial authentication request against the facial feature information 412 in the facial information DB 410 and returns the result of the comparison (the result of facial authentication) to the photographing control apparatus 200a. In this example, the assumption is that the facial authentication has succeeded, and the authentication apparatus 400 returns the result of facial authentication including the success of the facial authentication and the user ID 411 for which the facial authentication has succeeded to the photographing control apparatus 200a via the network X (response of success) (S224).

The determining unit 243 determines that the first facial authentication has succeeded based on the received result of facial authentication and then determines whether the first photographed image satisfies the photographing condition 212 (S225). In this example, the assumption is that the first photographed image satisfies the photographing condition 212, and the output unit 245 transmits a message indicating that photographing can be performed and the first photographed image to the user terminal 300 via the network X (S226). Herein, the output unit 245 can identify the user terminal 300 on the receiving end based on the user ID included in the result of facial authentication.

Next, the user terminal 300 displays the received message indicating that photographing can be performed and the first photographed image on the screen of the display unit 340 (S227). Next, the user terminal 300 receives an input of a photographing instruction via an operation of the person U (S228). Then, the user terminal 300 transmits the photographing instruction to the photographing control apparatus 200a via the network X. Thus, the photographing controlling unit 244 of the photographing control apparatus 200a receives the photographing instruction from the user terminal 300 (S229). Then, the photographing controlling unit 244 transmits the photographing instruction to the camera 100 via the network X (S230).

Then, the camera 100 performs photographing in accordance with the received photographing instruction and transmits a second photographed image to the photographing control apparatus 200a via the network X. Thus, the acquiring unit 241 of the photographing control apparatus 200a acquires the second photographed image from the user terminal 300 (S231). Next, the authentication controlling unit 242 detects a facial region from the second photographed image and extracts facial feature information from the facial region (S232). Then, the authentication controlling unit 242 transmits a facial authentication request including the extracted facial feature information to the authentication apparatus 400 via the network X (S233). Herein, steps S222 and S232 are not essential. In that case, the authentication controlling unit 242 incorporates the first photographed image or the detected facial region into the facial authentication request.

In response to the facial authentication request, the authentication apparatus 400 compares the facial feature information included in the facial authentication request against the facial feature information 412 in the facial information DB 410 and returns the result of the comparison (the result of facial authentication) to the photographing control apparatus 200a. In this example, the assumption is that the facial authentication has succeeded, and the authentication apparatus 400 returns the result of facial authentication including the success of the facial authentication and the user ID 411 for which the facial authentication has succeeded to the photographing control apparatus 200a via the network X (response of success) (S234).

In this instance, the determining unit 243 of the photographing control apparatus 200a determines that the second facial authentication has succeeded based on the received result of facial authentication. Then, the editing unit 246 identifies a facial region other than the facial region of the person U in the second photographed image and edits the second photographed image so as to reduce the recognizability of the identified facial region (S235). Then, the output unit 245 transmits the edited image as an output image to the user terminal 300 via the network X (S236). The user terminal 300 displays the received output image on the screen of the display unit 340 (S237).

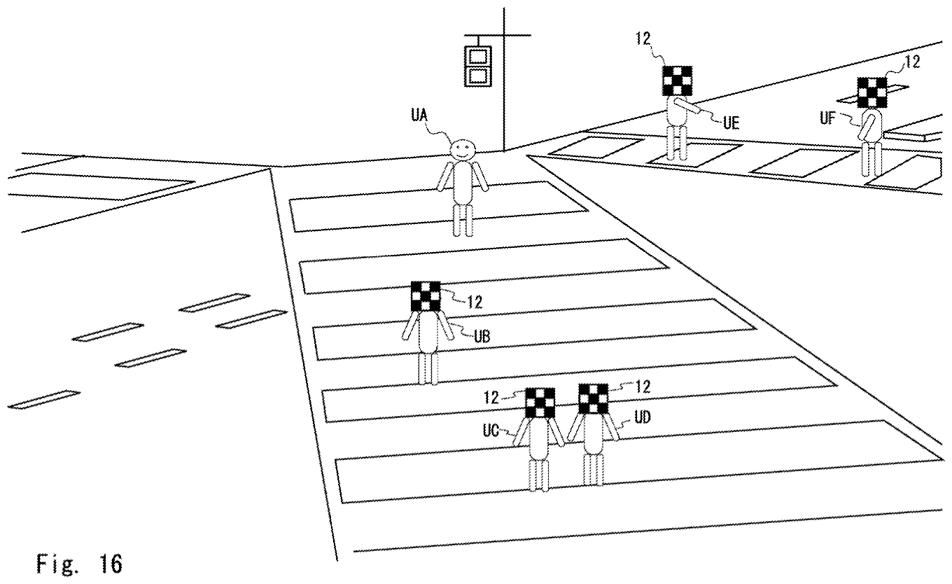

FIG. 16 illustrates an example of a photographed image in which faces of strangers are subjected to mosaic processing according to the fourth example embodiment. In FIG. 16, a person UA corresponds to the person U described above and is the person to be photographed. Facial regions of persons UB, UC, UD, UE, and UF other than the person UA are subjected to mosaic processing 12.

In this manner, the present example embodiment can protect privacy of a person, other than the person to be photographed, who has accidentally been captured in a photographed image.

### Fifth Example Embodiment

A fifth example embodiment is an improvement example of the third example embodiment described above and is a modification example of the fourth example embodiment. When a plurality of persons are captured in a photographed image, this may make it hard to identify the person to be photographed. Therefore, according to the fifth example embodiment, the surroundings of the person to be photographed are displayed prominently in a photographed image.

A photographing control apparatus according to the fifth example embodiment can be implemented by adding some changes to the contents of processing performed by the editing unit 246 of the photographing control apparatus 200a according to the fourth example embodiment. Therefore, drawings showing a photographing control system and the photographing control apparatus are omitted, and duplicate description thereof will be omitted.

The editing unit 246 according to the fifth example embodiment is an example of a second editing unit. If second facial authentication has succeeded, the editing unit 246 identifies, in the second photographed image, a facial region corresponding to the facial feature information that the second facial authentication has successfully authenticated and edits the second photographed image so as to emphasize the surroundings of the identified facial region. Then, the output unit 245 outputs the edited image to the user terminal 300 as an output image. Herein, the flow of a photographing control process according to the fifth example embodiment is similar to the flow illustrated in FIGS. 14 and 15 described above. However, at step S235, the photographed image is edited so as to emphasize the surroundings of the identified facial region, as described above.

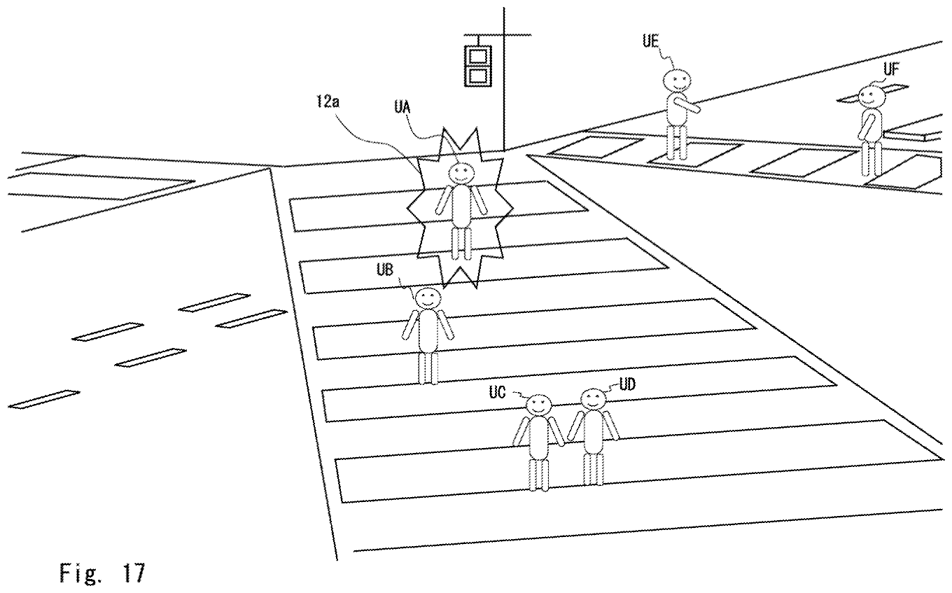

FIG. 17 illustrates an example of a photographed image in which the person is displayed prominently according to the fifth example embodiment. In FIG. 17, prominent display 12a is added to the surroundings of the facial region of the person U to be photographed.

In this manner, the present example embodiment prominently displays a person to be photographed identified through facial authentication, even when a plurality of persons are captured in the photographed image, and thus makes it easier to identify the person to be photographed.

### Sixth Example Embodiment

A sixth example embodiment is an improvement example of the third example embodiment described above. According to the third example embodiment, a photographing instruction for a second photographed image is made as the person U operates the user terminal 300. This operation can be cumbersome. Therefore, according to the sixth example embodiment, a gesture of the person U is taken as a photographing instruction. This configuration allows the person U to make a photographing instruction without operating the user terminal 300 and can thus ease the cumbersomeness.

A photographing control apparatus according to the sixth example embodiment can be implemented by adding some changes to the contents of processing performed by the acquiring unit 241, the photographing controlling unit 244, and the output unit 245 of the photographing control apparatus 200 according to the third example embodiment. Therefore, drawings showing a photographing control system and the photographing control apparatus are omitted, and duplicate description thereof will be omitted.

The output unit 245 according to the sixth example embodiment outputs at least a first photographed image to the user terminal 300 if the first photographed image satisfies a photographing condition. The acquiring unit 241 according to the sixth example embodiment acquires a third photographed image of the person U captured by the camera 100 after the output of the first photographed image. The photographing controlling unit 244 according to the sixth example embodiment assumes that a photographing instruction has been received if a predetermined gesture in the third photographed image is successfully recognized. In this example, a gesture is, for example, showing of a peace sign or posing with a raised hand. Any known technique can be used for gesture recognition. For example, the photographing controlling unit 244 analyzes the third photographed image and extracts a feature value of a posture of the person U. Alternatively, the photographing controlling unit 244 may extract a motion feature value of a motion of a person in the third photographed image. Then, the photographing controlling unit 244 identifies the type of the gesture based on the extracted feature value and determines the degree of match against the feature value of a predetermined gesture. If the degree of match is no lower than a predetermined value, the gesture may be regarded as being successfully recognized.

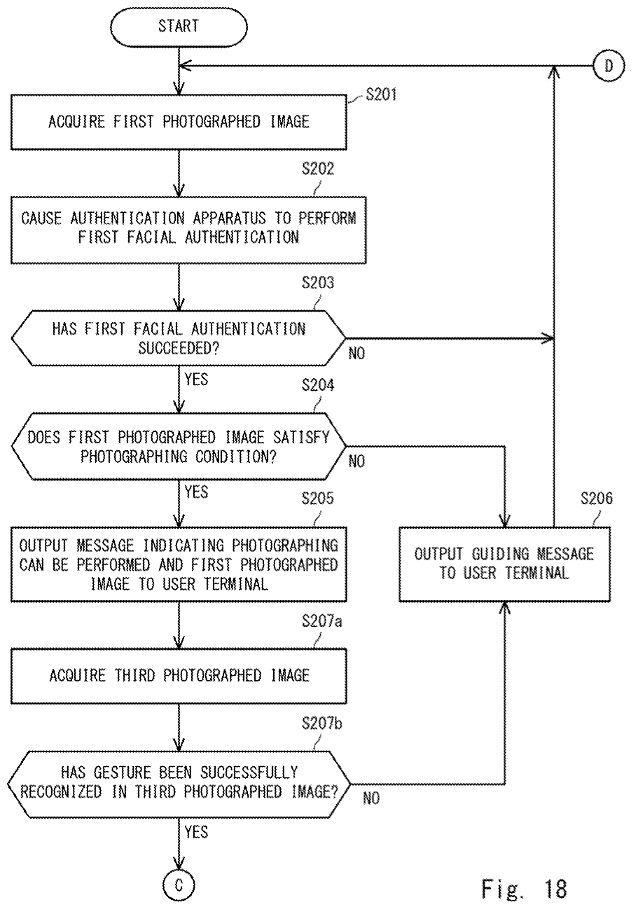

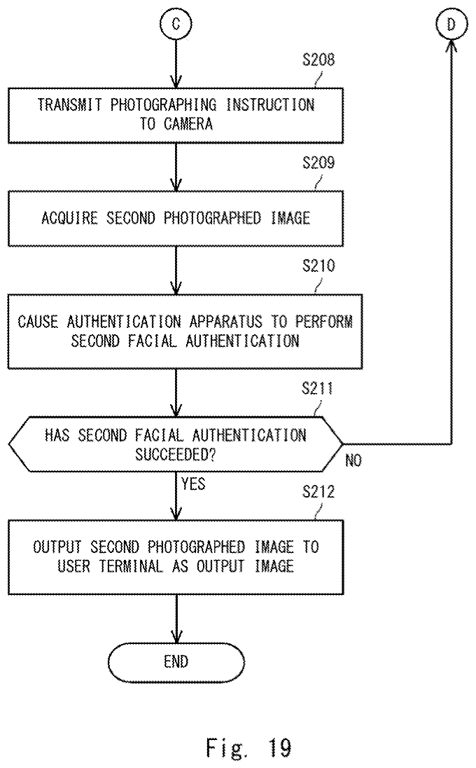

FIGS. 18 and 19 show a flowchart illustrating a flow of a photographing control process according to the sixth example embodiment. Herein, steps S201 to S206 are similar to those illustrated in FIG. 10 described above. After step S205, the acquiring unit 241 acquires a third photographed image of the person U captured by the camera 100 (S207a). Then, the photographing controlling unit 244 determines whether a gesture in the third photographed image has been recognized successfully (S207b). For example, the photographing controlling unit 244 may perform gesture recognition as described above. If the gesture has failed to be recognized, the process proceeds to step S206. Meanwhile, if the gesture has been recognized successfully, the photographing controlling unit 244 transmits a photographing instruction to the camera 100 via the network X (S208). The processes at and after step S209 are similar to those illustrated in FIG. 11 described above.

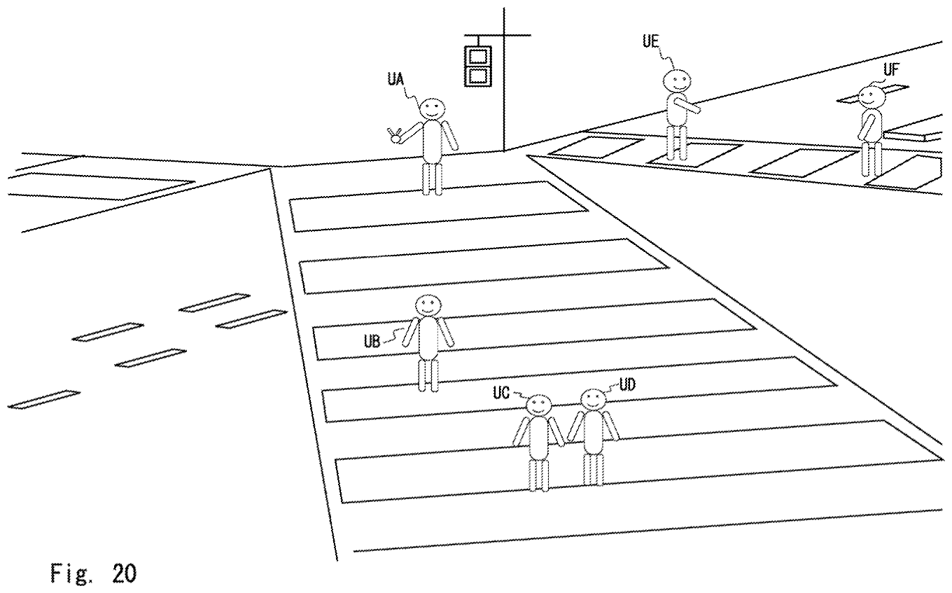

FIG. 20 illustrates an example of a photographed image with gesture recognition according to the sixth example embodiment. FIG. 20 shows that the gesture of the person UA has been recognized successfully.

In this manner, the present example embodiment allows a person who is to be photographed to make a photographing instruction without operating the user terminal 300 and can thus ease the cumbersomeness.

Herein, a predetermined gesture may differ for different users. For example, each user may register a predetermined gesture to be used for gesture recognition in his or her own photographing when registering his or her own facial information by use of a facial information registration terminal, the user terminal 300, or the like.

### Other Example Embodiments

The fourth and fifth example embodiments described above may be combined. In other words, a second photographed image may be subjected to mosaic processing and prominent display. This configuration makes it easier to identify the person to be photographed while considering the privacy of other persons photographed accidentally. The sixth example embodiment may be combined with one or both of the fourth and fifth example embodiments. A part or the whole of the third to sixth example embodiments may be applied to the second example embodiment described above.

The foregoing example embodiments have been described as hardware configurations, but these are not limiting examples. The present disclosure can also be implemented via desired processes by causing a CPU to execute a computer program.

In the foregoing examples, a program can be stored and provided to a computer by use of various types of non-transitory computer-readable media. Non-transitory computer-readable media include various types of tangible storage media. Examples of such non-transitory computer-readable media include a magnetic recording medium (e.g., flexible disk, magnetic tape, hard-disk drive), a magneto-optical recording medium (e.g., magneto-optical disk), a CD-ROM (read-only memory), a CD-R, a CD-R/W, a DVD (digital versatile disc), and a semiconductor memory (e.g., mask ROM, PROM (programmable ROM), EPROM (erasable PROM), flash ROM, RAM (random-access memory)). Meanwhile, a program may be supplied to a computer by use of various types of transitory computer-readable media. Examples of such transitory computer-readable media include an electric signal, an optical signal, and an electromagnetic wave. A transitory computer-readable medium can supply a program to a computer via a wired communication line, such as an electric wire or an optical fiber, or via a wireless communication line.

It is to be noted that the present disclosure is not limited to the foregoing example embodiments, and modifications can be made, as appropriate, within the scope that does not depart from the technical spirit. The present disclosure may also be implemented by combining the example embodiments, as appropriate.

A part or the whole of the foregoing example embodiments can also be described as in the following supplementary notes, which are not limiting.

### Supplementary Note A1

A photographing control devise comprising:

acquiring means configured to acquire a first photographed image of a person captured by a predetermined photographing device;

authentication controlling means configured to cause an authentication apparatus storing facial feature information of the person to perform first facial authentication of the first photographed image;

determining means configured, if the first facial authentication has succeeded, to determine whether the first photographed image satisfies a predetermined photographing condition and

output means configured, if the photographing condition is satisfied, to output a second photographed image of the person captured by the photographing device at a predetermined timing to a predetermined display device as an output image.

### Supplementary Note A2

The photographing control apparatus according to Supplementary note A1, wherein the output means is configured, if the photographing condition is not satisfied, to output a predetermined message to the display device.

### Supplementary Note A3

The photographing control apparatus according to Supplementary note A2, wherein the output means is configured to output, as the predetermined message, a message guiding the person in order to satisfy the photographing condition.

### Supplementary Note A4

The photographing control apparatus according to any one of Supplementary notes A1 to A3, further comprising photographing controlling means configured, if the photographing condition is satisfied, to cause the photographing device to capture the second photographed image in response to a photographing instruction received from the person.

### Supplementary Note A5

The photographing control apparatus according to Supplementary note A4, wherein

the output means is configured to output the first photographed image to the display device if the photographing condition is satisfied,

the acquiring means is configured to acquire a third photographed image of the person captured by the photographing device, after the first photographed image is output, and

the photographing controlling means is configured to assume that the photographing instruction has been received if a predetermined gesture in the third photographed image is successfully recognized.

### Supplementary Note A6

The photographing control apparatus according to Supplementary note A4 or A5, wherein

the display device is a display terminal associated with the facial feature information of the person,

the output means is configured to, if the first facial authentication has succeeded, output the first photographed image and a message indicating that photographing can be performed to the display terminal associated with the facial feature information that the first facial authentication has successfully authenticated,

the photographing controlling means is configured to receive the photographing instruction from the person via the display terminal, and

the output means is configured to output the second photographed image to the display terminal.

### Supplementary Note A7

The photographing control apparatus according to any one of Supplementary notes A1 to A3, wherein

the output means is configured, if the photographing condition is satisfied, to output, to the display device, an advance photographing notice to notify the person of the predetermined timing, and

the photographing control apparatus further comprises photographing controlling means configured to cause the photographing device to capture the second photographed image at the predetermined timing.

### Supplementary Note A8

The photographing control apparatus according to any one of Supplementary notes A4 to A7, wherein

the authentication controlling means is configured to cause the authentication apparatus to perform second facial authentication of the second photographed image by use of the facial feature information that the first facial authentication has successfully authenticated, and

the output means is configured, if the second authentication has succeeded, to output the second photographed image to the display device as the output image.

### Supplementary Note A9

The photographing control apparatus according to Supplementary note A8, further comprising first editing means configured to, if the second facial authentication has succeeded, identify, in the second photographed image, a facial region other than a facial region corresponding to the facial feature information that the second facial authentication has successfully authenticated and to edit the second photographed image so as to reduce recognizability of the identified facial region,

wherein the output means is configured to output the edited image to the display device as the output image.

### Supplementary Note A10

The photographing control apparatus according to Supplementary note A8 or A9, further comprising second editing means configured to, if the second facial authentication has succeeded, identify, in the second photographed image, a facial region corresponding to the facial feature information that the second facial authentication has successfully authenticated and to edit the second photographed image so as to emphasize surroundings of the identified facial region,

wherein the output means is configured to output the edited image to the display device as the output image.

### Supplementary Note A11

The photographing control apparatus according to any one of Supplementary notes A1 to A10, wherein the photographing condition includes that a facial region of the person lies within a specific region in a photographed image.

### Supplementary Note A12

The photographing control apparatus according to any one of Supplementary notes A1 to A11, wherein the photographing condition includes that the degree of crowding caused by persons detected in a photographed image is no lower than a predetermined value.

### Supplementary Note B1

A photographing control apparatus comprising:

storing means configured to store facial feature information of a predetermined person;

acquiring means configured to acquire a first photographed image of the person captured by a predetermined photographing device;

authentication controlling means configured to perform first facial authentication of the first photographed image by use of the facial feature information;

determining means configured, if the first facial authentication has succeeded, to determine whether the first photographed image satisfies a predetermined photographing condition; and

output means configured, if the photographing condition is satisfied, to output a second photographed image of the person captured by the photographing device at a predetermined timing to a predetermined display device as an output image.

### Supplementary Note C1

A photographing control system comprising:

a photographing device;

an authentication apparatus including storing means storing facial feature information of a predetermined person and authenticating means configured to perform facial authentication by use of the facial feature information;

a display device; and

a photographing control apparatus,

wherein the photographing control apparatus includes
acquiring means configured to acquire a first photographed image of a person captured by the photographing device,
authentication controlling means configured to cause the authentication apparatus to perform first facial authentication of the first photographed image,
determining means configured, if the first facial authentication has succeeded, to determine whether the first photographed image satisfies a predetermined photographing condition, and
output means configured, if the photographing condition is satisfied, to output a second photographed image of the person captured by the photographing device at a predetermined timing to the display device as an output image.

### Supplementary Note C2

The photographing control system according to Supplementary note C1, wherein the output means is configured to output a predetermined message to the display device if the photographing condition is not satisfied.

### Supplementary Note D1

A photographing control method executed by a computer, the photographing control method comprising:

acquiring a first photographed image of a person captured by a predetermined photographing device;

causing an authentication apparatus storing facial feature information of the person to perform first facial authentication of the first photographed image;

determining, if the first facial authentication has succeeded, whether the first photographed image satisfies a predetermined photographing condition; and

outputting, if the photographing condition is satisfied, a second photographed image of the person captured by the photographing device at a predetermined timing to a predetermined display device as an output image.

### Supplementary Note E1

A photographing control method executed by a computer configured to store facial feature information of a predetermined person, the photographing control method comprising:

acquiring a first photographed image of a person captured by a predetermined photographing device;

performing first facial authentication of the first photographed image by use of the facial feature information;

determining, if the first facial authentication has succeeded, whether the first photographed image satisfies a predetermined photographing condition; and

outputting, if the photographing condition is satisfied, a second photographed image of the person captured by the photographing device at a predetermined timing to a predetermined display device as an output image.

### Supplementary Note F1

A non-transitory computer-readable medium storing a photographing control program that causes a computer to execute:

a process of acquiring a first photographed image of a person captured by a predetermined photographing device;

a process of causing an authentication apparatus storing facial feature information of the person to perform first facial authentication of the first photographed image;

a process of determining, if the first facial authentication has succeeded, whether the first photographed image satisfies a predetermined photographing condition; and

a process of outputting, if the photographing condition is satisfied, a second photographed image of the person captured by the photographing device at a predetermined timing to a predetermined display device as an output image.

### Supplementary Note G1

A non-transitory computer-readable medium storing a photographing control program that causes a computer configured to store facial feature information of a predetermined person to execute:

a process of acquiring a first photographed image of a person captured by a predetermined photographing device;

a process of performing first facial authentication of the first photographed image by use of the facial feature information;

a process of determining, if the first facial authentication has succeeded, whether the first photographed image satisfies a predetermined photographing condition; and

a process of outputting, if the photographing condition is satisfied, a second photographed image of the person captured by the photographing device at a predetermined timing to a predetermined display device as an output image.

Thus far, the invention of the present application has been described with reference to some example embodiments (and examples). The invention of the present application, however, is not limited to the foregoing example embodiments (and examples). Various modifications that a person skilled in the art can appreciate can be made to the configurations and the details of the invention of the present application within the scope of the invention of the present application.

### REFERENCE SIGNS LIST

2 PHOTOGRAPHING CONTROL APPARATUS

2a PHOTOGRAPHING CONTROL APPARATUS

21 ACQUIRING UNIT

22 AUTHENTICATION CONTROLLING UNIT

22a AUTHENTICATING UNIT

23 DETERMINING UNIT

24 OUTPUT UNIT

25 STORAGE UNIT

251 FACIAL FEATURE INFORMATION

1000 PHOTOGRAPHING CONTROL SYSTEM

100 CAMERA

200 PHOTOGRAPHING CONTROL APPARATUS

200a PHOTOGRAPHING CONTROL APPARATUS

210 STORAGE UNIT

211 PROGRAM

212 PHOTOGRAPHING CONDITION

220 MEMORY

230 COMMUNICATING UNIT

240 CONTROLLING UNIT

241 ACQUIRING UNIT

242 AUTHENTICATION CONTROLLING UNIT

243 DETERMINING UNIT

244 PHOTOGRAPHING CONTROLLING UNIT

245 OUTPUT UNIT

246 EDITING UNIT

300 USER TERMINAL

310 CAMERA

320 STORAGE UNIT

330 COMMUNICATING UNIT

340 DISPLAY UNIT

350 CONTROLLING UNIT

351 PHOTOGRAPHING UNIT

352 REGISTERING UNIT

400 AUTHENTICATION APPARATUS

410 FACIAL INFORMATION DB

411 USER ID

412 FACIAL FEATURE INFORMATION

420 FACE DETECTING UNIT

430 FEATURE POINT EXTRACTING UNIT

440 REGISTERING UNIT

450 AUTHENTICATING UNIT

U PERSON

UA, UB, UC, UD, UE, UFPERSON

X NETWORK

12 MOSAIC PROCESSING

12a PROMINENT DISPLAY

What is claimed is:

1. A photographing control devise comprising:
at least one storage device configured to store instructions; and
at least one processor configured to execute the instructions to:
acquire a first photographed image of a person captured by a predetermined photographing device;
cause an authentication apparatus storing facial feature information of the person to perform first facial authentication of the first photographed image;
determine, if the first facial authentication has succeeded, whether the first photographed image satisfies a predetermined photographing condition and
output, if the photographing condition is satisfied, a second photographed image of the person captured by the photographing device at a predetermined timing to a predetermined display device as an output image.

2. The photographing control apparatus according to claim 1,
wherein the at least one processor is further configured to execute the instructions to:
output, if the photographing condition is not satisfied, a predetermined message to the display device.

3. The photographing control apparatus according to claim 2,
wherein the at least one processor is further configured to execute the instructions to:
output, as the predetermined message, a message guiding the person in order to satisfy the photographing condition.

4. The photographing control apparatus according to claim 1,
wherein the at least one processor is further configured to execute the instructions to:
cause, if the photographing condition is satisfied, the photographing device to capture the second photographed image in response to a photographing instruction received from the person.

5. The photographing control apparatus according to claim 4,
wherein the at least one processor is further configured to execute the instructions to:
output the first photographed image to the display device if the photographing condition is satisfied,
acquire a third photographed image of the person captured by the photographing device, after the first photographed image is output, and
assume that the photographing instruction has been received if a predetermined gesture in the third photographed image is successfully recognized.

6. The photographing control apparatus according to claim 4, wherein
the display device is a display terminal associated with the facial feature information of the person, and
wherein the at least one processor is further configured to execute the instructions to:
output, if the first facial authentication has succeeded, the first photographed image and a message indicating that photographing can be performed to the display terminal associated with the facial feature information that the first facial authentication has successfully authenticated,
receive the photographing instruction from the person via the display terminal, and
output the second photographed image to the display terminal.

7. The photographing control apparatus according to claim 1,
wherein the at least one processor is further configured to execute the instructions to:
output, to the display device, an advance photographing notice to notify the person of the predetermined timing, if the photographing condition is satisfied, and
cause the photographing device to capture the second photographed image at the predetermined timing.

8. The photographing control apparatus according to claim 4,
wherein the at least one processor is further configured to execute the instructions to:
cause the authentication apparatus to perform second facial authentication of the second photographed image by use of the facial feature information that the first facial authentication has successfully authenticated, and
output, if the second authentication has succeeded, the second photographed image to the display device as the output image.

9. The photographing control apparatus according to claim 8,
wherein the at least one processor is further configured to execute the instructions to:
if the second facial authentication has succeeded, identify, in the second photographed image, a facial region other than a facial region corresponding to the facial feature information that the second facial authentication has successfully authenticated and edit the second photographed image so as to reduce recognizability of the identified facial region, and
output the edited image to the display device as the output image.

10. The photographing control apparatus according to claim 8,
wherein the at least one processor is further configured to execute the instructions to:
if the second facial authentication has succeeded, identify, in the second photographed image, a facial region corresponding to the facial feature information that the second facial authentication has successfully authenticated and edit the second photographed image so as to emphasize surroundings of the identified facial region, and
output the edited image to the display device as the output image.

11. The photographing control apparatus according to claim 1, wherein the photographing condition includes that a facial region of the person lies within a specific region in a photographed image.

12. The photographing control apparatus according to claim 1, wherein the photographing condition includes that the degree of crowding caused by persons detected in a photographed image is no lower than a predetermined value.

13. A photographing control apparatus comprising:
at least one storage device configured to store instructions and facial feature information of a predetermined person; and
at least one processor configured to execute the instructions to:
acquire a first photographed image of the person captured by a predetermined photographing device;
perform first facial authentication of the first photographed image by use of the facial feature information;
determine, if the first facial authentication has succeeded, whether the first photographed image satisfies a predetermined photographing condition; and
output, if the photographing condition is satisfied, a second photographed image of the person captured by the photographing device at a predetermined timing to a predetermined display device as an output image.

14. A photographing control system comprising:
a photographing device;
an authentication apparatus including at least one first storage device configured to store first instructions and facial feature information of a predetermined person and at least one first processor configured to execute the first instructions to: perform facial authentication by use of the facial feature information;
a display device; and
a photographing control apparatus,
wherein the photographing control apparatus includes
at least one second storage device configured to store second instructions; and
at least one second processor configured to execute the second instructions to:
acquire a first photographed image of a person captured by the photographing device,
cause the authentication apparatus to perform first facial authentication of the first photographed image, determine, if the first facial authentication has succeeded, whether the first photographed image satisfies a predetermined photographing condition, and
output, if the photographing condition is satisfied, a second photographed image of the person captured by the photographing device at a predetermined timing to the display device as an output image.

15. A photographing control system according to claim 14,
wherein the at least one second processor is further configured to execute the second instructions to:
output a predetermined message to the display device if the photographing condition is not satisfied.

16. A photographing control method executed by a computer, the photographing control method comprising:
acquiring a first photographed image of a person captured by a predetermined photographing device;
causing an authentication apparatus storing facial feature information of the person to perform first facial authentication of the first photographed image;
determining, if the first facial authentication has succeeded, whether the first photographed image satisfies a predetermined photographing condition; and
outputting, if the photographing condition is satisfied, a second photographed image of the person captured by the photographing device at a predetermined timing to a predetermined display device as an output image.

17. A photographing control method executed by a computer configured to store facial feature information of a predetermined person, the photographing control method comprising:
acquiring a first photographed image of a person captured by a predetermined photographing device;
performing first facial authentication of the first photographed image by use of the facial feature information;
determining, if the first facial authentication has succeeded, whether the first photographed image satisfies a predetermined photographing condition; and
outputting, if the photographing condition is satisfied, a second photographed image of the person captured by the photographing device at a predetermined timing to a predetermined display device as an output image.

18. A non-transitory computer-readable medium storing a photographing control program that causes a computer to execute:
a process of acquiring a first photographed image of a person captured by a predetermined photographing device;
a process of causing an authentication apparatus storing facial feature information of the person to perform first facial authentication of the first photographed image;
a process of determining, if the first facial authentication has succeeded, whether the first photographed image satisfies a predetermined photographing condition; and
a process of outputting, if the photographing condition is satisfied, a second photographed image of the person captured by the photographing device at a predetermined timing to a predetermined display device as an output image.

19. A non-transitory computer-readable medium storing a photographing control program that causes a computer configured to store facial feature information of a predetermined person to execute:
a process of acquiring a first photographed image of a person captured by a predetermined photographing device;
a process of performing first facial authentication of the first photographed image by use of the facial feature information;
a process of determining, if the first facial authentication has succeeded, whether the first photographed image satisfies a predetermined photographing condition; and
a process of outputting, if the photographing condition is satisfied, a second photographed image of the person captured by the photographing device at a predetermined timing to a predetermined display device as an output image.
